(19) United States
(12) Patent Application Publication
(10) Pub. No.: US 2021/0079950 A1
(43) Pub. Date: Mar. 18, 2021

(54) SAFETY SUPPORT APPARATUS

(71) Applicant: James Hendricks, Virden, IL (US)

(72) Inventor: James Hendricks, Virden, IL (US)

(21) Appl. No.: 16/959,655

(22) PCT Filed: Dec. 28, 2018
(86) PCT No.: PCT/US18/67916

§ 371 Date: Jul. 1, 2020

Related U.S. Application Data
(60) Provisional application No. 62/614,715, filed on Jan. 8, 2018.
(60) Provisional application No. 62/732,400, filed on Sep. 17, 2018.

(51) Int. Cl. F16C 11/10; B62D 65/16

(52) U.S. Cl. CPC F16C 11/103; B62D 65/16

(57) ABSTRACT

Embodiments of the present invention provide a safety support apparatus for truck beds elevated in a raised position. The bottom of the safety support apparatus provides a support platform a clamping mechanism which adjusts to truck chassis designs providing rails of varying thicknesses. The top of the safety support apparatus provides a receiver which may be configured with several modular components to engage the bottom of an elevated truck bed.

### CROSS-REFERENCE TO RELATED APPLICATIONS

This application claims the benefit of U.S. Provisional Application No. 62/614,715, filed Jan. 8, 2018, and U.S. Provisional Application No. 62/732,400, filed Sep. 17, 2018.

### BACKGROUND OF THE INVENTION

In transportation, dump trucks are used to transport materials in an open- box bed, pivotably hinged at the rear and raiseable by powered drives at the front. In operation, a truck bed may be placed in a raised configuration for a prolonged period of time to grant service personnel physical clearance to access mechanisms on the underside of the truck bed. The elevation of a truck bed for a protracted length of time poses safety complications for personnel at work under the truck bed, due to the risk of accidental release of the truck bed from an elevated position. A structural support may be imposed beneath an elevated truck bed to reduce the risk of accidental release. However, the structural support itself must be secured to prevent the support from accidental slippage or dislocation.

U.S. Pat. No. 6,905,174 to Gilbertson et al. discloses a safety support device for truck beds. The Gilbertson support device provides a channel rest which supports the truck bed, pivotably bolted to an upright shank. The shank, supported by a brace, rests on a base platform which rests on a truck chassis frame. However, the Gilbertson support device cannot be secured to the truck chassis frame without employing chains that wrap around the truck chassis frame.

Gilbertson's channel rest must support the weight of the truck bed, yet it is equipped with only a narrow bracket on its underside that bolts to Gilbertson's upright shank. Thus, the sides of Gilbertson's channel rest overhang the shank and are not directly supported. Under stress from the truck bed for protracted periods of time, Gilbertson's channel rest may warp under strain, decreasing the safety of Gilbertson's support device over long-term use. Further, Gilbertson's rigid channel rest limits the size of truck chassis frame the support device may be used in conjunction with, thereby limiting the applicability of the support device or requiring a user to obtain multiple different sizes in order to accommodate a wide range of truck types and sizes.

Furthermore, the expressly recited need to rely on chains to secure Gilbertson's support device to a truck chassis frame results in a cumbersome operation process. As disclosed, methods for using Gilbertson's support device comprise no fewer than nine steps and as many as nineteen steps, to account for the need to manually hook, fasten, unfasten, and unhook the support chains.

Emerson Manufacturing of Pender, NE provides various safety support devices for truck beds. Emerson provides a “Safety Wedge Lock” in the form of an upright triangular frame which serves as a pivot for an inverted triangular frame. In operation, the upright frame rests upon a chassis frame of a truck and the inverted frame is “wedged” under a side of a raised truck bed.

However, the base of the Emerson device merely provides a bracket that encloses the sides of the truck chassis frame, and thus the Emerson device provides no mechanism for securing the base to the truck chassis frame. Thus, the Emerson device may dislodge from a wedged position under the truck bed; this permits the truck bed to suddenly fall, creating a potential safety hazard. Under stress from the truck bed for protracted periods of time, the risk of dislodgment may increase.

A safety support device has not been proposed or suggested to resolve the problem of burdensome or insecure fastening against a truck chassis, or the problem of warming due to supporting weight for prolonged periods of time.

### BRIEF DESCRIPTION OF THE DRAWINGS

FIG. 1 illustrates perspective view of a safety support apparatus according to an embodiment of the present invention.

FIG. 2 illustrates a cross-section view of the safety support apparatus in configuration with a truck chassis frame.

FIG. 3 illustrates a cross-section view of the safety support apparatus with extension insert coupled to a truck chassis frame.

FIG. 4A illustrates an exploded view of a support platform and receiver configuration of the safety support apparatus.

FIG. 4B illustrates a perspective view a support platform and receiver configuration of the safety support apparatus while coupled to a truck chassis frame.

FIG. 4C illustrates a perspective view of a roller guides and receiver embodiment of the safety support apparatus while coupled to a truck chassis frame.

FIG. 5A illustrates a profile view of the safety support apparatus configured with a horizontal support member.

FIG. 5B illustrates a perspective view of the safety support apparatus configured with a horizontal support member.

FIG. 6 illustrates a profile view of the safety support apparatus.

### DETAILED DESCRIPTION OF THE INVENTION

Embodiments of the present invention provide a safety support apparatus for truck beds elevated in a raised position. A bottom of the safety support apparatus provides a support platform having a clamping mechanism adjustable to truck chassis designs having rails of varying thicknesses. A top of the safety support apparatus provides a receiver which may be configured with several modular components to engage the bottom of an elevated truck bed.

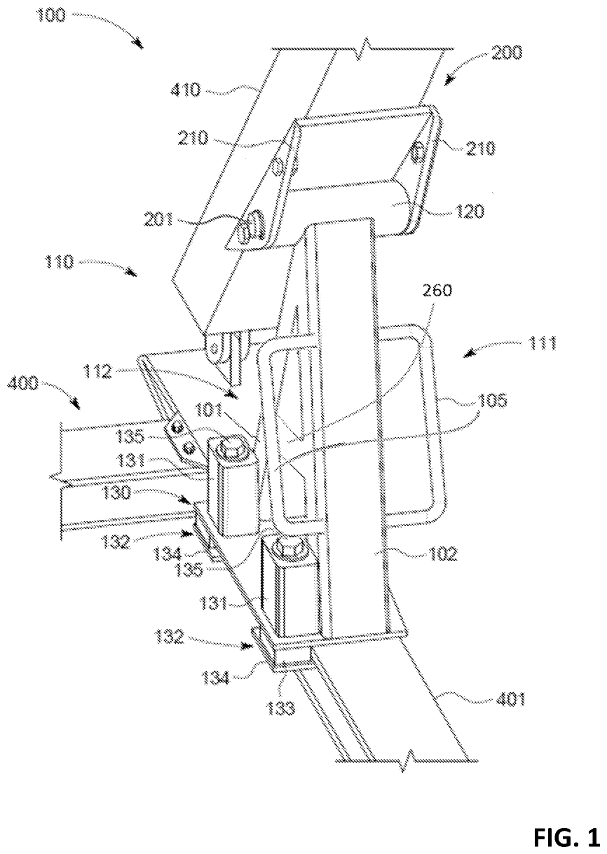

FIG. 1 illustrates a perspective view of a support apparatus 100 according to an embodiment of the present invention. The support apparatus 100 has an anterior member 101 and a posterior member 102 together forming a truss frame 110 having a top, a bottom, and at least one side. The truss frame 110 further comprises a first lateral face 111 and a second lateral face 112. The support apparatus 100 further comprises a base member 130 coupled to the bottom of the truss frame 110. The support apparatus 100 further comprises a receiver 120 coupled to and laterally spanning the top of the truss frame 110. The receiver 120 may be configured to overhang each face of the truss frame 110.

To the first lateral face 111 or the second lateral face 112 of the truss frame 110, at least one handle 105 may be affixed to the anterior member 101, the posterior member 102, or both. Disposed through the base member 130 of the support apparatus, one or more clamp housings 131 are coupled to the base member 130. Each clamp housing 131 further comprises a lengthwise passage through the clamp housing 131, the passage configured with access at its top through a fastener receiver at a top of the clamp housing 131 and access at its bottom through an opening disposed through the base member 130. A clamp member 132 may be disposed through a passage of a clamp housing 131 by insertion into the opening disposed through the base member 130. Conversely, a clamp member 132 may be removed from the passage of the clamp housing 131 through the opening disposed through the base member 130. In some embodiments, one or more handles may be affixed to the anterior member, the posterior member, or both, of the second face of the truss frame, allowing for easier transport and storage of the apparatus.

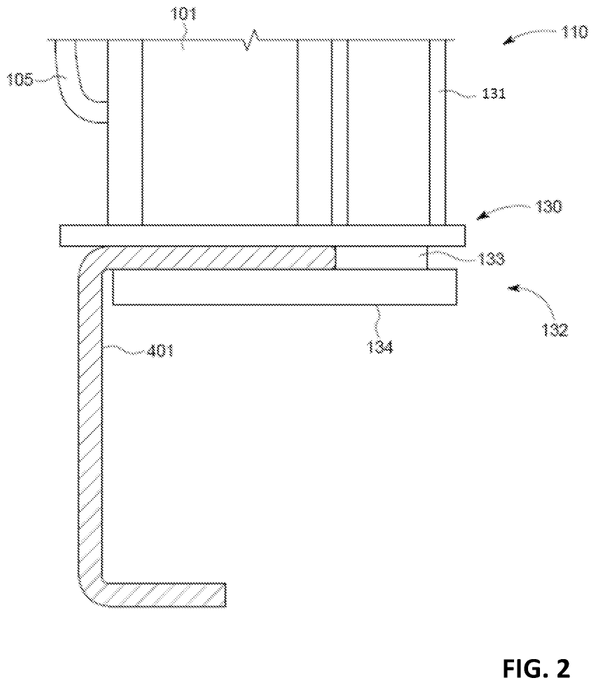

A clamp member 132, shown in FIG. 2, further comprises a sliding member 133 having a first end and a second end, adjustable upward and downward through a range of positions within the clamp housing 131, and a clamp jaw plate 134 set at the second end of the sliding member 133, wherein the clamp jaw plate 134 halts upward adjustment of the sliding member 133 within the clamp housing 131. While the sliding member 133 is inserted within the clamp housing 131, an adjustable fastener 135 may be fastened through the top opening of the clamp housing 131 to the clamp member 132. The adjustable fastener 135 may be coupled to the sliding member and configured to adjust the sliding member 133 through a range of positions within the clamp housing 131 so as to open the clamp jaw plate 134 and provide a variable clearance between the base member 130 and the clamp jaw plate 134.

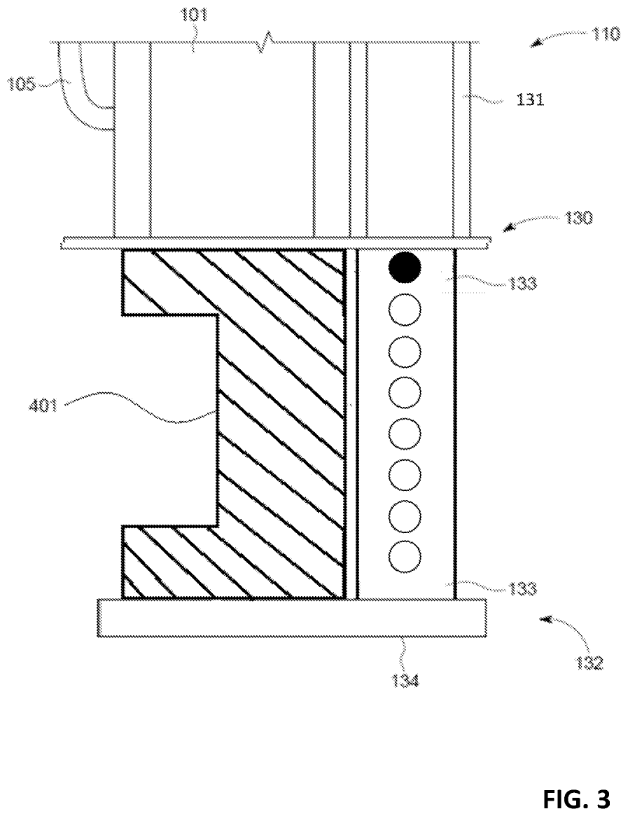

In another embodiment of the invention, shown in FIG. 3, the sliding member 133 may further comprise an elongated member configured to lengthen the apparatus 100 and enable fastening of the apparatus to a rail of greater thickness, thereby increasing overall stability and adaptability of the apparatus when used with various types of truck designs. In another embodiment of the invention, the apparatus 100 may further comprise an extension insert (not shown), configured to couple both the base member 130 and the sliding member 133. The extension insert may further comprise a plurality of notches configured to allow adjustment of an overall clamping area of the apparatus 100 by removably coupling the sliding member 133 at a plurality of adjustment points disposed through at least one surface thereof. Further, the extension insert, in conjunction with the sliding member 133 and clamp jaw plate 134, may be configured to allow the apparatus 100 to be stored in an upright standing position.

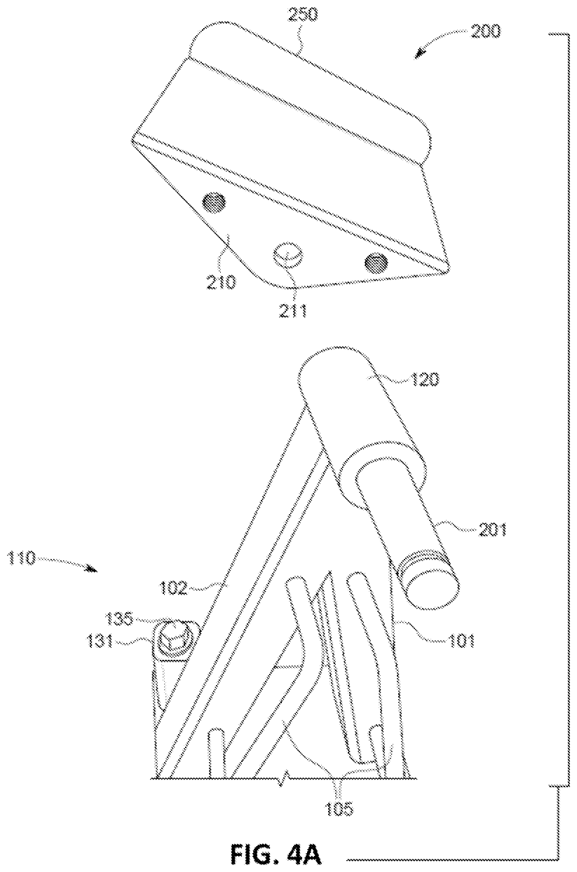

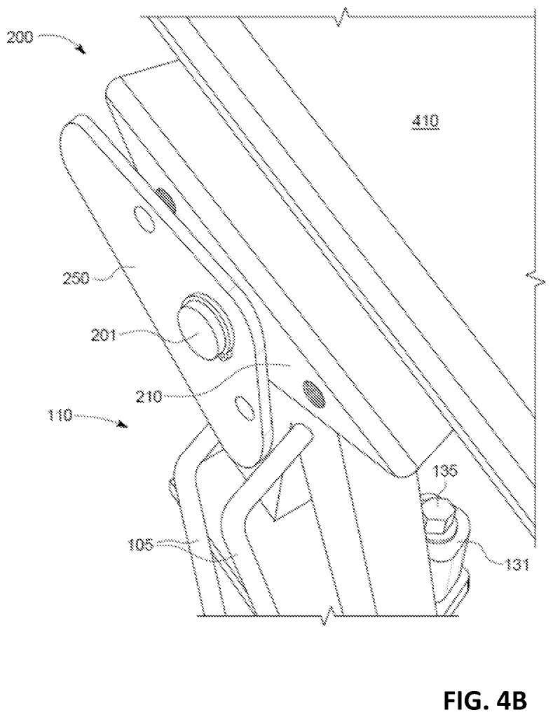

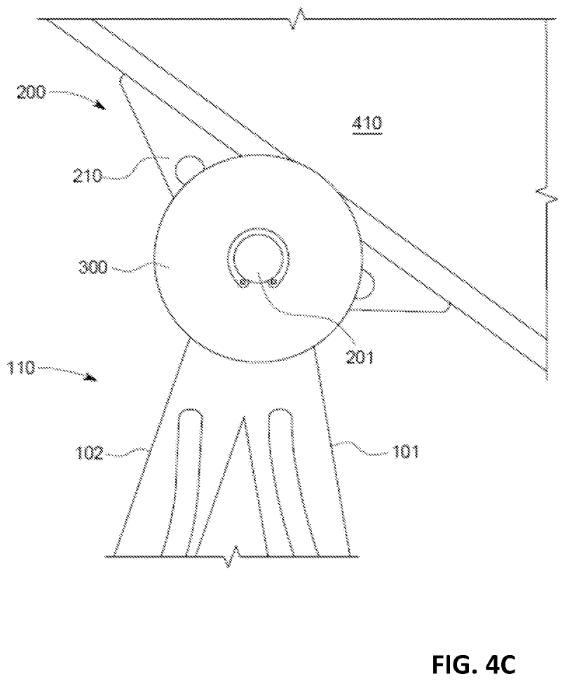

The receiver 120, as shown in FIG. 4A-B, may comprise any elongated form allowing imposition of a shaft 201 through the receiver 120. According to embodiments of the present invention, the receiver 120 may be cylindrical in form.

Shown in FIG. 4A, the receiver 120 may be configured to couple a support platform 200, further configured to pivot about a central axis of the receiver 120. Two opposing sides of the support platform 200 may provide brackets 210 having sufficient clearance in between to span the length of the receiver 120. The brackets 210 may each be a structure spanning the length of a side of the support platform 200. A pivot receiver 211 may further be disposed through each bracket 210. With the brackets 210 abutting the receiver 210, a shaft 201 may be inserted through the brackets 210 and the receiver 120 to pivotably mount the support platform 200 to the receiver 120. At least one pivot stop (not shown) may further be coupled to the brackets and an underside of the support platform, spanning the length of the support platform and configured to limit pivotability of the support platform about the central axis of the receiver.

While the support platform 200 is pivotably mounted to the receiver 120, the receiver 120 may be configured to receive platform guides 250 on either side of the support platform 200. A platform guide 250 may be a plate structure aligned and abutting a bracket 210 of the support platform 200 such that a portion 251 of the platform guide 250 protrudes over the top of the support platform 200. While in alignment with a bracket 210, the platform guide 250 may be coterminous with one or more edges of the bracket 210 excluding the portion 251 protruding over the top of the support platform 200.

The platform guide 250 may be moveably fastened to the shaft 201 such that the platform guide 250 may be pivoted into alignment with a bracket 210 or may be pivoted out of alignment with the bracket 210 as illustrated in FIG. 4B. While in alignment with the bracket 210, the platform guide 250 may be fastened to the bracket 210 at one or more points of the bracket 210. Handles 105 of the anterior member 101 and of the posterior member 102 may each be configured such that the platform guide 250 may pivot fully about the shaft 201 without obstruction by a handle 105.

Alternately, the receiver 120 may be configured to receive roller guides 300 instead of a support platform 200 as illustrated in FIG. 4C. With a shaft 201 imposed through the receiver 120, a roller guide 300 may be fastened to each end of the shaft 201. A roller guide 300 may be a disc member which circumscribes a side of the receiver 120 such that an object resting upon the receiver 120 is secured in its lateral motion against roller guides 300 fastened to either end of the shaft 201.

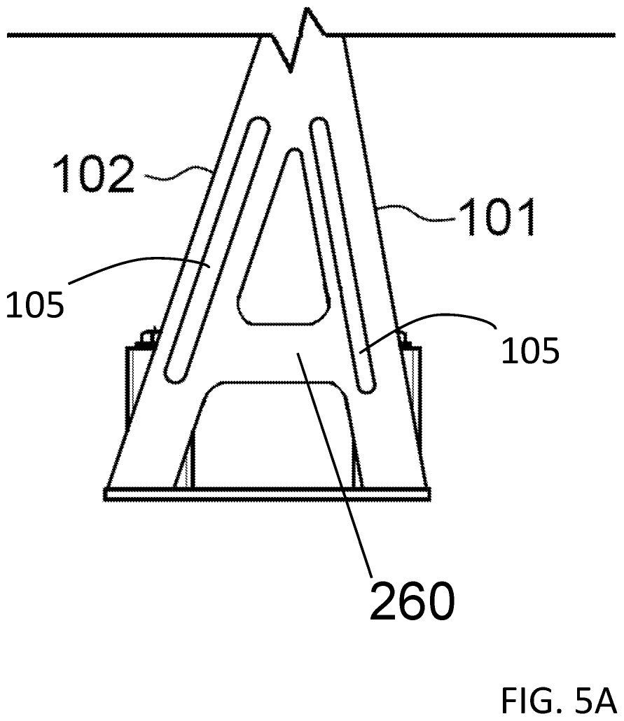

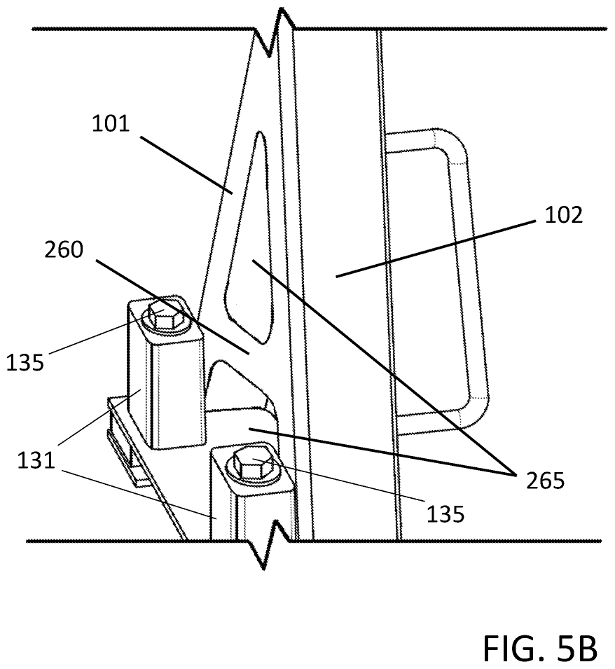

In another embodiment, shown in FIGS. 5A-B, the support apparatus 100 further comprises at least one horizontal support member 260, coupled at a first end to the posterior member 102 and coupled at a second end to the anterior member 101. The at least one horizontal support member 260 is configured to link both the posterior and anterior members 102, 101 to one another and increase overall structural stability of the support apparatus 100. In similar embodiments, the at least one horizontal support member 260 is configured to link the posterior member 102 and anterior member 101 and increase overall structural stability such that the posterior member 102 and the anterior member 101 may be further configured as open structures. In this embodiment, the at least one horizontal support member 260 and the posterior and anterior members 102, 101 are configured to form a central cavity 265 within the truss frame 110 of the support apparatus 100; thereby reducing carry weight of the apparatus 100 without reducing structural integrity.

Further, the central cavity 265 is configured such that an overall amount of materials and time needed to manufacture the apparatus 100 is significantly reduced without reducing structural integrity, as the apparatus 100 may be constructed from fewer pieces of material. Further, the support apparatus 100 would require fewer connecting welds than other support apparatuses known in the art, thereby decreasing time needed for manufacturing processes.

In some embodiments of the invention, the at least one handle may comprise a plurality of handles 105 may be configured such that at least one handle of the plurality of handles 105 is disposed upon opposite facing surfaces of the anterior member 101 or of the posterior member 102. The plurality of handles 105 are further configured such that a user may place, remove, or adjust the apparatus 100 from either side of the apparatus 100. Additionally, the plurality of handles 103 may also be configured to allow ease of transport of the apparatus 100 both during use and non-use.

In other embodiments of the invention, the platform guide 250 may be absent, and the support platform 200 may be configured such that load pressure alone forms a frictional coupling between the support platform 200 and a truck bed 410. Further, the bracket 210 may further be configured such that it may only pivot about the shaft 201 in a partial arc, rather than fully, adding additional stability to the support platform in absence of the platform guide 250.

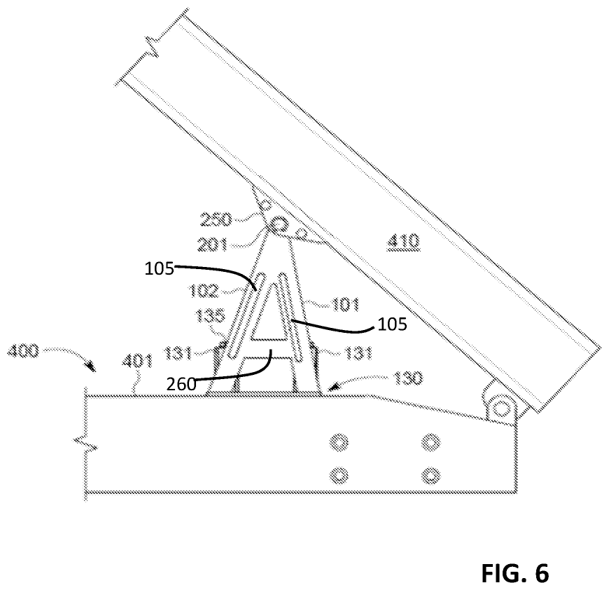

In operation, a support apparatus 100 may be engaged as follows with a lengthwise rail 401 of a truck chassis 400 having a bed 410, where the bed 410 is pivoted in the raised position, as shown in FIG. 6.

A support apparatus 100 may be configured for operation, first by manipulating the adjustable fastener 135 to open the clamp jaw plate 134. The receiver 120 may then be configured either with a support platform 200, without platform guides 250, with a support platform 200 having platform guides 250, or with roller guides 300.

A support apparatus 100 may be carried by the at least one handle 105 and placed with the base member 130 resting upon a lengthwise rail 401 of a truck chassis 400, with the anterior member 101 facing a head of the truck and the posterior member 102 facing a tail of the truck. The clamp jaw plate 134 may be imposed under the lengthwise rail 401 such that the lengthwise rail 401 is situated between the base member 130 and the clamp jaw plate 134.

The support apparatus 100 may be moved laterally along the lengthwise rail 401 until the support platform 200 is in contact with the bottom of the bed 410 or until the receiver 120 is in contact with the bottom of the bed 410. The bottom of the bed 410 may be braced between the platform guides 250 or between the roller guides 300 to secure the bottom of the bed 410 against the support platform 200 or against the receiver 120.

The adjustable fastener 135 may be adjusted to close the clamp jaw plate 134 about the lengthwise rail 401 to place the base member 130 and the clamp jaw plate 134 within a locked coupling about the lengthwise rail 401, as illustrated in FIG. 4. Such a locked coupling may accommodate a range of approximately ¼ to ⅜ of an inch, inclusive.

The above steps may be performed a second time upon a second lengthwise rail 401 of the truck chassis 400 using a second support apparatus 100.

Embodiments of the present invention provide a safety support for raised truck beds, with a mechanism for locking the safety support against the truck chassis without burdensome or unsafe fasteners. Furthermore, embodiments of the present invention provide multiple modular configurations for a support platform that engages against the bottom of a truck bed. The integration of bracket structures spanning the sides of the support platform may guard the support platform against warping due to prolonged pressure from supporting a truck bed.

While particular elements, embodiments, and applications of the present invention have been shown and described, the invention is not limited thereto because modifications may be made by those skilled in the art, particularly in light of the foregoing teaching. It is therefore contemplated by the application to cover such modifications and incorporate those features which come within the spirit and scope of the invention.

What is claimed is:

1. A support apparatus, comprising:
a. a truss frame;
b. a base member at the bottom of the truss frame;
c. an engagement unit at the top of the truss frame;
d. wherein a clamp member is set upon the base member at a side of the truss frame.

2. The support apparatus of claim 1, wherein the truss frame comprises an anterior member and a posterior member.

3. The support apparatus of claim 2, wherein at least one of the anterior member has at least one handle coupled to at least one side thereof.

4. The support apparatus of claim 2, wherein at least one of the posterior member has at least one handle coupled to at least one side thereof.

5. The clamp member of claim 1, further comprising a clamp housing and a clamp counterpart slidably imposed through the clamp housing.

6. The support apparatus of claim 5, further comprising an adjustable fastener coupled through the clamp housing to the clamp counterpart.

7. The support apparatus of claim 6, wherein the clamp counterpart further comprises a sliding member and a clamp jaw plate.

8. The support apparatus of claim 7, wherein the adjustable fastener is adjustable to slide the sliding member through a range of positions within the clamp housing so as to provide a variable clearance between the base member and the clamp jaw plate.

9. The support apparatus of claim 8, wherein the truss frame further comprises at least one horizontal support member coupled at a first end to the posterior member and coupled at a second end to the anterior member, the at least one horizontal support member configured to link the posterior member and anterior member and increase structural stability.

10. The support apparatus of claim 1, further comprising a support platform having brackets, wherein the support platform is pivotably mounted to the receiver.

11. The support apparatus of claim 10, wherein a shaft is imposed through the brackets and the receiver.

12. The support apparatus of claim 11, further comprising platform guides pivotably mounted to two sides of the support platform.

13. The support apparatus of claim 12, wherein a platform guide is fastened to the support platform such that a dominating portion of a platform guide protrudes over the top of the support platform.

14. The support apparatus of claim 1, wherein the engagement unit comprises:
a. a receiver;
b. a shaft imposed through the receiver; and
c. a roller guide fastened to each end of the shaft.

15. A method comprising:
a. placing the base member of the support apparatus of claim 1 upon a rail of a truck chassis having a truck bed;
b. moving the support apparatus of claim 1 laterally along the rail until the engagement unit is in engagement with the bottom of the truck bed; and
c. adjusting the clamp to form a locking fit about the rail.

16. The method of claim 15, wherein the truss frame comprises an anterior member and a posterior member; and wherein the base member is placed upon the rail such that the anterior member faces a head of the truck and the posterior member faces a tail of the truck.

17. The method of claim 15, wherein the clamp comprises a clamp housing and a clamp counterpart slidably imposed through the clamp housing.

18. The method of claim 15, wherein the engagement unit comprises a support platform having brackets and a receiver; wherein the support platform is pivotably mounted to the receiver.

19. The method of claim 15, wherein the engagement unit comprises:
a. a receiver;
b. a shaft imposed through the receiver; and
c. a roller guide fastened to each end of the shaft.
